(19) United States
(12) Patent Application Publication
(10) Pub. No.: US 2006/0277703 A1
(43) Pub. Date: Dec. 14, 2006

(54) Paint pellet gun able to replace a pellet tube quickly

(76) Inventor: Pao-Tung Shih, Tainan City (TW)

Correspondence Address: Pao-Tung Shih, P.O. Box 90, Tainan City, 70499, TW

(21) Appl. No.: 11/147,200

(22) Filed: Jun. 8, 2005

(51) Int. Cl. F16L 45/00; B08B 9/04; F16L 55/00; B08B 1/00; B08B 7/00

(52) U.S. Cl. 15/104.062

(57) ABSTRACT

A paint pellet gun able to replace a pellet tube quickly includes a pellet tube holder assembled on the pellet-dropping hole of a gun body. The pellet tube holder is bored with a pellet-dropping hole, an insert hole having one side cut with a horizontal insert slot, and a vertical engage groove communicating with the horizontal insert slot. A pellet tube combined with the pellet tube holder has its interior formed with an accommodating chamber and its front end bored with a pellet intake and a bolt-sliding groove and is further provided with a projecting rod. A pellet stopping block is fixed with the front end of the pellet tube by a bolt, having one side formed with a stop member for blocking up the pellet intake, convenient in paint pellet loading and able to replace the pellet tube quickly.

### BACKGROUND OF THE INVENTION

1. Field of the Invention

This invention relates to a paint pellet gun able to replace a pellet tube quickly, particularly to one provided with a pellet tube holder on the pellet dropping hole of the gun body. The pellet tube holder is bored with a pellet dropping hole and an insert hole having one side cut with a horizontal insert slot. The pellet tube holder is further bored with a vertical engage groove communicating with the horizontal insert slot. A pellet tube to be combined with the pellet tube holder has its interior formed with an accommodating chamber and its front end bored with a pellet intake and a bolt sliding groove and also provided with a projecting rod. A pellet-stopping block is fixed at the front end of the pellet tube by an engage bolt inserted through the bolt sliding groove and has one side formed with a stopping member for blocking up the pellet intake. By so designing, paint pellets can be loaded conveniently and the pellet tube can be replaced quickly for carrying out paint pellet shooting smoothly.

2. Description of the Prior Art

A conventional paint pellet gun 1 has a pellet tube 11 secured on the gun body 10, as shown in FIGS. 1 and 2. The pellet tube 11 has one end fitted in a pellet intake tube 12 having its topside bored with a pellet intake 120 and its underside bored with a lengthwise hole 121. Further, the pellet tube 11 has its lower side bored with a pellet-dropping hole 111 aligned to the pellet-dropping hole 13 in the topside of the gun body 10. To load paint pellets (A), the pellet intake tube 12 has to be pulled backward first so that paint pellets (A) can be loaded in the pellet tube 11 through the pellet intake 120. After finishing loading of paint pellets (A) in the pellet tube 11, the pellet intake tube 12 is pushed forward to push against one end of the pellet tube 11. In operating, as shown in FIG. 2, firstly, it is necessary to raise upward the front end of the gun body 10 to let the paint pellets (A) in the pellet tube 11 move backward. Then, the striking rod 14 of the paint pellet gun 1 is pulled backward to let the paint pellets (A) drop into the bore of the gun body 10 for shooting through the pellet dropping hole 111 of the pellet tube 11 and the pellet dropping hole 13 of the gun body 10.

However, the pellet tube 11 of the conventional paint pellet gun 1 is firmly fixed on the gun body 10; therefore, when all the paint pellets (A) in the pellet tube 11 are used up, shooting has to be stopped temporarily before the pellet tube 11 is loaded with new paint pellets (A), inconvenient in use. In addition, in operating of the conventional paint pellet gun 1, after shooting one paint pellet (A), it is necessary to raise upward the front end of the gun body 10 to let the paint pellets (A) in the pellet tube 11 move backward and drop into the pellet dropping hole for shooting, resulting in much trouble in operating.

### SUMMARY OF THE INVENTION

The objective of the invention is to offer a paint pellet gun able to replace a pellet tube quickly.

The paint pellet gun able to replace a pellet tube quickly in the present invention includes a gun body having its topside bored with a pellet-dropping hole. A pellet tube holder assembled on the pellet dropping hole of the gun body has its lower side bored with a pellet dropping hole aligned to the pellet dropping hole of the gun body and its rear side bored with an insert hole having one side cut with a horizontal insert slot, and further has its upper side bored with a vertical engage groove communicating with the horizontal insert slot. A pellet tube to be combined with the pellet tube holder has its interior formed with an accommodating chamber and its front end bored with a pellet intake and a bolt sliding groove, and one side provided with a projecting rod. A pellet-stopping block is fitted in the front end of the pellet tube by an engage bolt inserted through the bolt-sliding groove and has one side formed a stop member for blocking up the pellet intake.

### BRIEF DESCRIPTION OF DRAWINGS

This invention will be better understood by referring to the accompanying drawings, wherein:

FIG. 1 is a cross-sectional view of a conventional paint pellet gun;

FIG. 2 is a cross-sectional view of the conventional paint pellet gun in a using condition;

FIG. 3 is a perspective view of a paint pellet gun and a pellet tube separated from each other in the present invention;

FIG. 4 is an exploded perspective view of the pellet tube of the paint pellet gun in the present invention;

FIG. 5 is a cross-sectional view of the pellet tube in a paint pellets loading condition in the present invention;

FIG. 6 is a cross-sectional view of the pellet tube loaded therein with paint pellets in the present invention;

FIG. 7 is a perspective view of the paint pellet gun able to replace a pellet tube quickly in the present invention;

FIG. 8 is a cross-sectional view of the pellet tube in a first operating condition in the present invention;

FIG. 9 is a cross-sectional view of the pellet tube in a second operating condition in the present invention;

FIG. 10 is a cross-sectional view of the pellet tube in a third operating condition in the present invention;

FIG. 11 is a side cross-sectional view of the pellet tube having the threaded rod of a pellet pushing member pulled and engaged in a transverse notch in the present invention; and,

FIG. 12 is a side cross-sectional view of the pellet tube having the threaded rod moved and positioned in a lengthwise slide slot in the present invention.

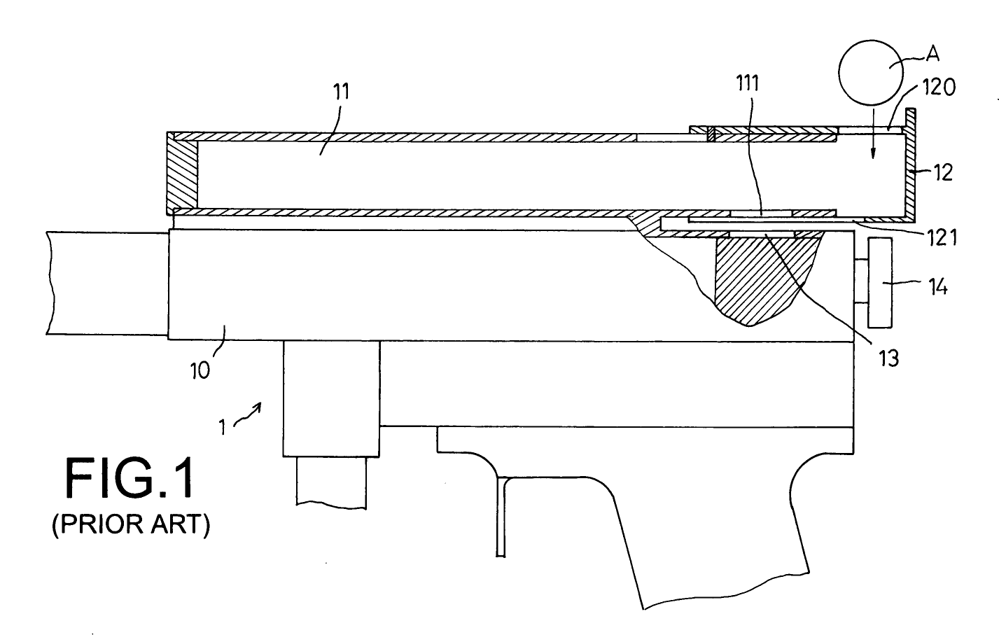

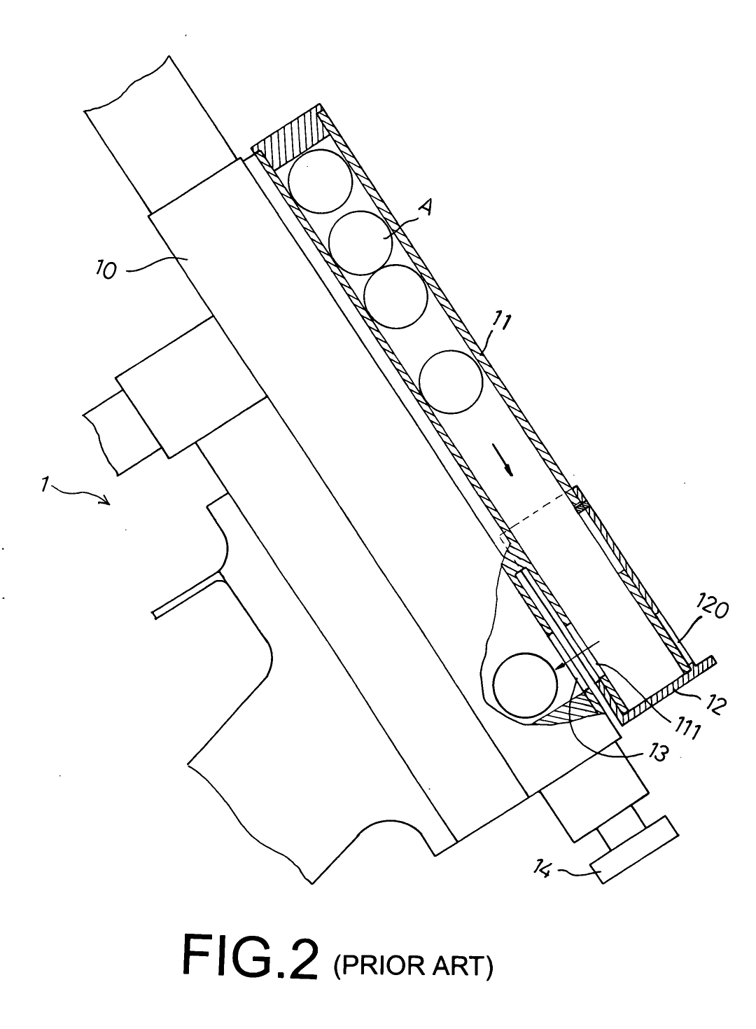

### DETAILED DESCRIPTION OF THE PREFERRED EMBODIMENT

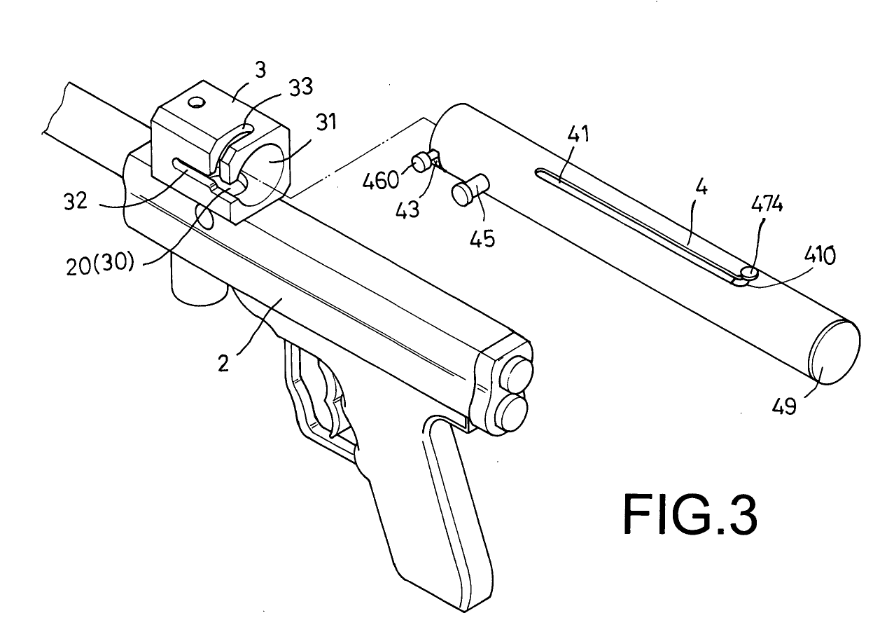

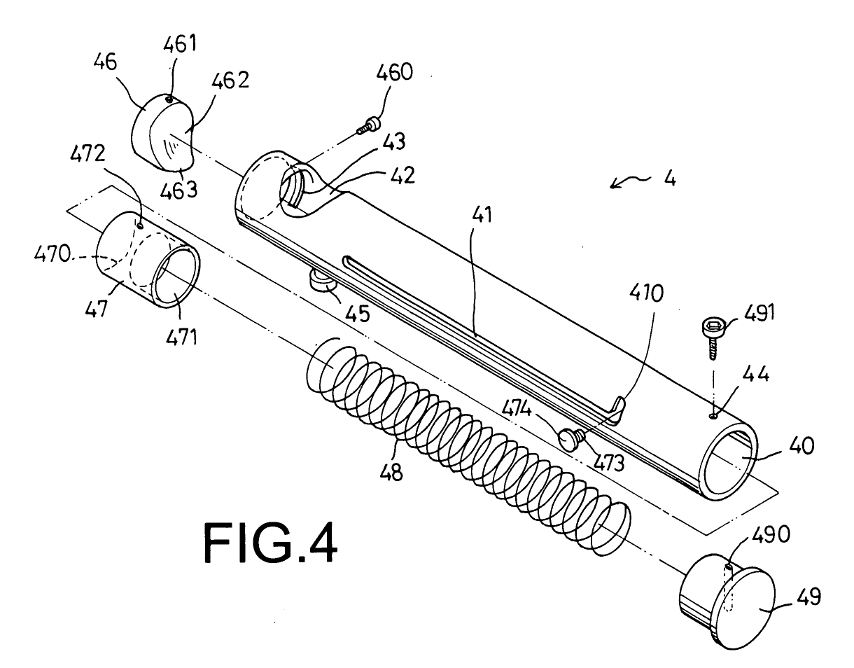

A preferred embodiment of a paint pellet gun able to replace a pellet tube quickly in the present invention, as shown in FIGS. 3 and 4, includes a gun body 2, a pellet tube holder 3 and a pellet tube 4 combined together.

The gun body has its front end bored with a pellet-dropping hole 20.

The pellet tube holder 3 assembled on the pellet dropping hole 20 of the gun body 2 has its lower side bored with a pellet dropping hole 30 aligned to the pellet dropping hole 20 of the gun body 2 and its rear side bored with an insert hole 31 having one side cut with a horizontal insert slot 32. The pellet tube holder 3 is further bored with a vertical engage groove 33 communicating with the horizontal insert slot 32.

The pellet tube 4 combined with the pellet tube holder 3 has its interior formed with an accommodating space 40 and one side bored with an lengthwise slide slot 41 having on end formed with a transverse notch 410. Further, the pellet tube 4 has its front end bored with a pellet intake 42 and a transverse bolt sliding groove 43 and its rear end bored with an insert hole 44, and also has the backside of its pellet intake 42 fixed with a projecting rod 45. A pellet-stopping block 46 with a bolthole 461 is fitted in the front end of the pellet tube 4 by an engage bolt 460. The pellet stopping block 46 has one side formed with an arc-shaped surface 462 having its lower side formed with a stop member 463 extending outward.

In addition, the pellet tube 4 has its rear end fitted therein with a pellet pushing member 47, an extension spring 48 and a stop block 49. The pellet-pushing member 47 positioned in the pellet tube 4 has its front side formed with an arc-shaped recessed surface 470 and its rear side formed with a recessed hole 471. The pellet-pushing member 47 is further bored with a threaded hole 472 for a threaded rod 473 to be screwed therein. The threaded rod 473 has one end formed with a projecting head 474 extending out of the lengthwise slide slot 41 of the pellet tube 4. The extension spring 48 has one end fitted in the recessed hole 471 of the pellet-pushing member 47 and the other end pushing against the inner side of the stop block 49 having a threaded hole 490 and firmly fitted in the rear end of the pellet tube 4 by a bolt 491.

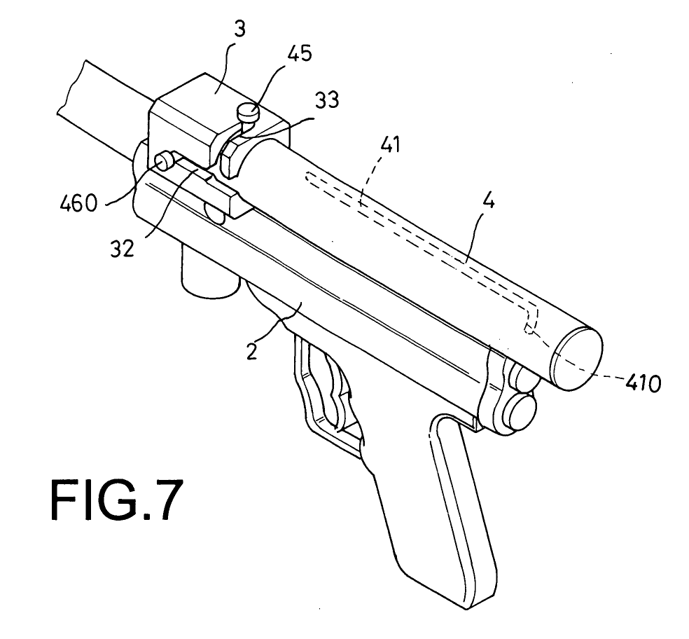

In assembling of the pellet tube 4, as shown in FIGS. 3 to 7, firstly, the pellet stopping block 46 is positioned in the front end of the pellet tube 4, letting the bolt hole 461 of the pellet stopping block 46 aligned to the bolt sliding groove 43 of the pellet tube 4. Next, the engage bolt 460 is inserted through the bolt-sliding groove 43 and screwed with the bolthole 461 to fix the pellet-stopping block 46 at the front end of pellet tube 4. Then, the pellet pushing member 47, the extension spring 48 and the stop block 49 are orderly fitted in the rear end of the pellet tube 4. The pellet pushing member 47 is first installed in the pellet tube 4, letting the threaded hole 472 of the pellet pushing member 47 aligned to the slide slot 41 of the pellet tube 4, and the threaded rod 473 is inserted through the slide slot 41 of the pellet tube 4 and screwed with the threaded hole 472 of the pellet pushing member 47 and then engaged in the transverse notch 410 of the pellet tube 4 and positioned therein temporarily. Subsequently, the extension spring 48 has one end positioned in the recessed hole 471 of the pellet-pushing member 47 and the other end pushing against the inner side of the stop block 49. Finally, the stop block 49 is firmly fitted in the rear end of the pellet tube 4 to finish assembly of the pellet tube 4.

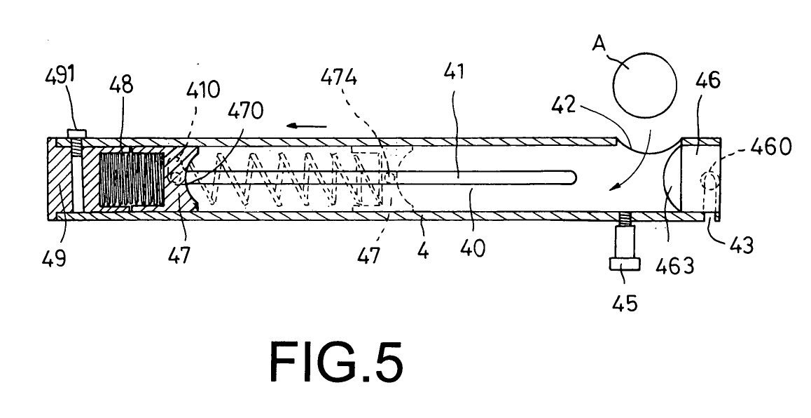

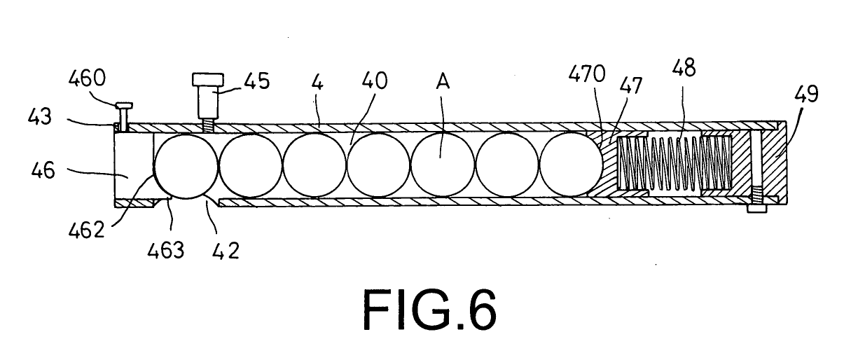

To load the pellet tube 4 with paint pellets (A), referring to FIGS. 5 and 6, firstly, the pellet pushing member 47 is pushed by the threaded rod 473 to move close to the stop block 49 and then have the threaded rod 473 engaged in the transverse notch 410 of the pellet tube 4 and positioned therein temporarily. Then, the engage bolt 460 is pulled along the bolt sliding groove 43 to actuate the pellet stopping block 46 to turn and have its stopping member 463 moved away from the pellet intake 42 so that paint pellets (A) can be loaded in the accommodating chamber 40 of the pellet tube 4 through the pellet intake 42. After the accommodating chamber 40 of the pellet tube 4 is fully loaded with paint pellets (A), the engage bolt 460 is pushed along the bolt sliding groove 43 to move to its original location that is in alignment with the projecting rod 45, letting the stopping member 463 of the pellet stopping block 46 prop the lower edge of the paint pellet (A) to prevent it from dropping down through the pellet intake 42.

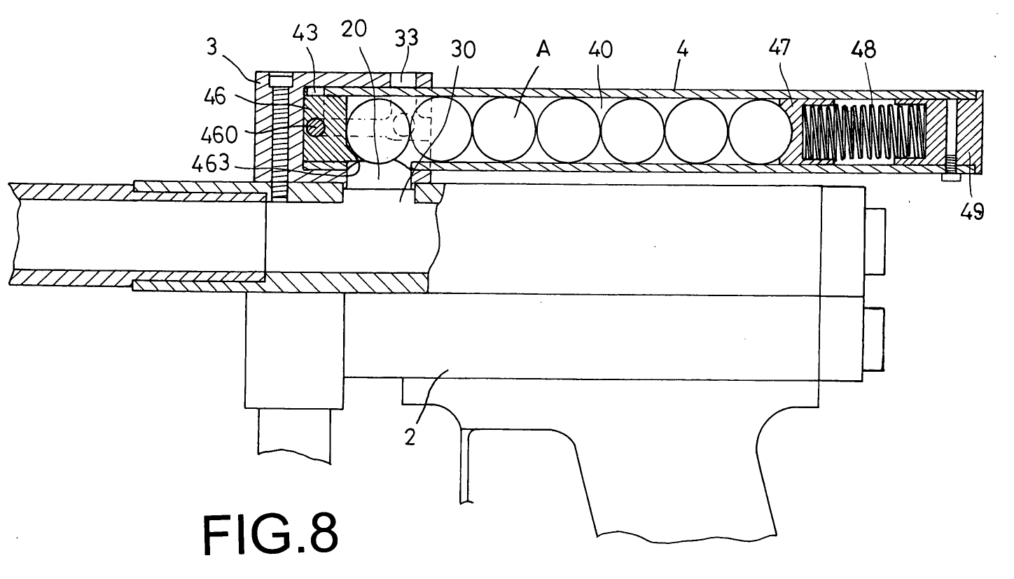

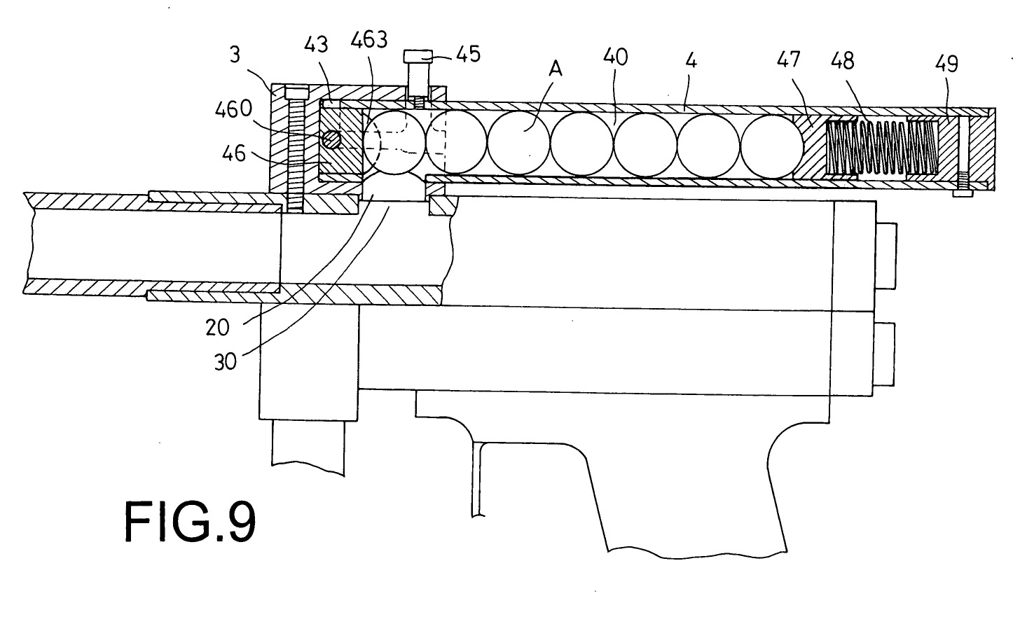

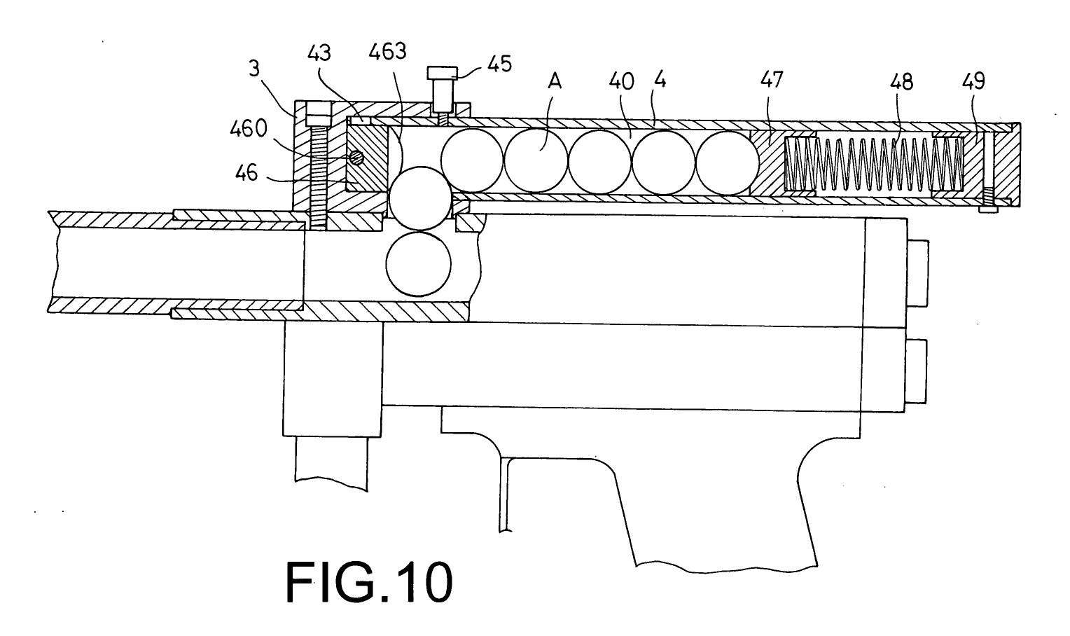

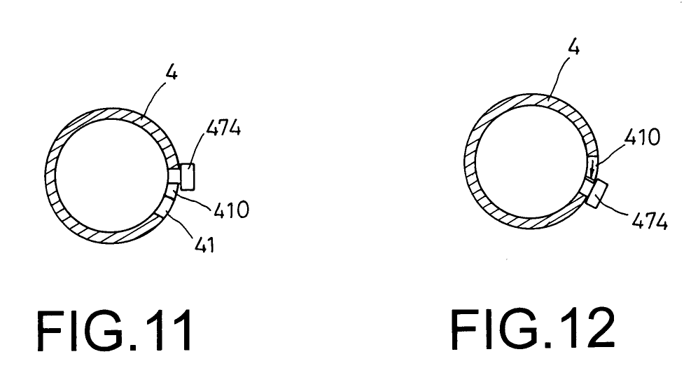

In operating and using, referring to FIGS. 3 and 8 to 12, the pellet tube 4 loaded with paint pellets (A) has its pellet intake 42 facing downward and let the engage bolt 460 inserted in the horizontal insert slot 32 of the pellet tube holder 3 and the projecting rod 45 aligned to the vertical engage groove 33 of the pellet tube holder 3. Then, turn the pellet tube 4 to let its projecting rod 45 engaged in the vertical engage groove 33 of the pellet tube holder 3 and simultaneously, since the engage bolt 460 is stopped by the horizontal insert slot 32 of the pellet tube holder 3, the stopping member 463 of the pellet stopping block 46 is shifted not to block the pellet intake 42 any longer. Next, pull the projecting head 474 of the threaded rod 743 on the pellet pushing member 47 to move the threaded rod 473 away from the transverse notch 410 and make it slide into the lengthwise slide slot 41 to release the pellet pushing member 47 from being restricted in position. Thus, by the resilience of the extension spring 48, the pellet pushing member 47 will automatically push the paint pellets (A) to move to the pellet intake 42 and drop into the bore of the gun body 2 for shooting through the pellet dropping hole 30 of the pellet tube holder 3 and the pellet dropping hole 20 of the gun body 2. After shooting one paint pellet (A), the pellet-pushing member 47 forced by the extension spring 48 will automatically push the other paint pellets (A) forward to fill the vacancy for carrying out shooting continuously.

Thus, a user can carry several spare pellet tubes 4 at the same time to be replaced for use when the paint pellets (A) in one pellet tube 4 are used up, convenient in pellet loading. By so designing, the pellet tube 4 of this invention can be loaded with paint pellets conveniently and replaced quickly and also has function of pushing and delivering paint pellets (A) automatically.

While the preferred embodiment of the invention has been described above, it will be recognized and understood that various modifications may be made therein and the appended claims are intended to cover all such modifications that may fall within the spirit and scope of the invention.

What is claimed is:

1. A paint pellet gun able to replace a pellet tube quickly comprising:
a gun body having its topside bored with a pellet-dropping hole;
a pellet tube holder assembled on said pellet dropping hole of said gun body, said pellet tube holder having its lower side bored with a pellet dropping hole aligned to said pellet dropping hole of said gun body, said pellet tube holder having its rear side bored with an insert hole, said insert hole having one side cut with a horizontal insert slot, said pellet tube holder bored with a vertical engage groove communicating with said horizontal insert slot; and,
a pellet tube combined with said pellet tube holder, said pellet tube having its interior formed with an accommodating space, said pellet tube having its front end bored with a pellet intake and a bolt sliding groove, said pellet tube further provided with a projecting rod and a pellet stopping block, said pellet stopping block firmly fitted in the front end of said pellet tube by an engage bolt inserted through said bolt sliding groove, said pellet stopping block having one side formed with a stop member extending outward for blocking up said pellet intake of said pellet tube.

2. The paint pellet gun able to replace a pellet tube quickly as claimed in claim 1, wherein said pellet tube is bored with a lengthwise slide slot having its rear end cut with a transverse notch and has its rear end fitted therein with a pellet pushing member, an extension spring and a stop block, said pellet pushing member screwed thereon with a threaded rod, said threaded rod having one end formed with a projecting head extending out of said lengthwise slide slot of said pellet tube, said extension spring having one end pushing against said pellet pushing member and the other end pushing against the inner side of said stop block, said stop block firmly fitted in the rear end of said pellet tube.
